(19) United States
(12) Patent Application Publication
(10) Pub. No.: US 2003/0130928 A1
(43) Pub. Date: Jul. 10, 2003

(54) Method of creating and distributing real estate marketing packages utilizing the internet

(76) Inventor: Eric Ross Chozick, West Hartford, CT (US)

Correspondence Address: Eric R. Chozick, 336 Mountain Road, West Hartford, CT, 06107, US

(21) Appl. No.: 10/193,101

(22) Filed: Jul. 12, 2002

Related U.S. Application Data
(60) Provisional application No. 60/346,636, filed on Jan. 10, 2002.

(51) Int. Cl. G06F 17/60

(52) U.S. Cl. 705/37

(57) ABSTRACT

Means and method of creating and distributing real estate marketing sales packages utilized in the conduct of real estate business are described wherein an individual utilizing the computer programming developed may create, customize and distribute marketing materials through the use of the internet. The process utilized streamlines and enables the user of this system to create highly technical and comprehensive real estate marketing packages even if possessing only limited expertise in the fields of real estate and/or marketing. The method further offers the intended recipient of the real estate marketing package near instantaneous access and delivery of the real estate marketing package utilizing the internet as the means of delivery without need for downloading the document.

### CROSS-REFERENCE TO RELATED APPLICATIONS

This application claims the benefit of PPA Ser. No. 60/346,636 filed Jan. 10, 2002, by the present inventor.

### SEQUENCE LISTING OR PROGRAM

Appendix A contains a CD containing the programming code of the invention, written in the computer programming languages of Microsoft visual basic; HTML, Microsoft active server pages, Microsoft VB script and Java script. Programming in a Microsoft IIS environment. Realtyinvestor.er1 contains a database diagram for reference.

### BACKGROUND OF THE INVENTION

1. Field of the Invention

The subject invention relates to the use of the internet in creating and distributing real estate marketing packages and more particularly to a system and method for the user of the invention to create and deliver, and for an intended recipient to receive through the use of the internet, real estate marketing packages in a time and cost effective manner. Further the invention provides for those with limited knowledge in the fields of real estate and marketing the ability to create comprehensive and technically detailed real estate marketing packages.

2. Background

Real Estate is by nature of the investment category a relatively illiquid asset class. Property transfers traditionally requiring the marketing of the asset by a seller or a professional real estate broker to a large group of potential buyers or lessees. The marketing process may take from several months to a period of years in cases. Given the inherent illiquid nature of the asset class extensive marketing of real property is often required by the seller or lessor and/or its agent “Offeror” with significant marketing cost and time invested. In a successful marketing campaign of real estate it is important for the seller or its agent to possess significant knowledge in the field of real estate and marketing. Through the use of various marketing techniques the potential buyers or lessees are contacted by the Offeror, offering the available property. Customarily this is accomplished through direct contact or through means of utilization of various advertising media such as newspapers and trade journals.

Real estate is comprised of the physical assets of the land and structures thereon, if any, as well as in the case of investment or development real estate the investment attributes of the real estate in terms of income and expenses at the time of sale and future projected cash streams generated by the investment. Conveyance of technical information associated with real estate is customarily reduced to a written document called a real estate marketing package or offering package, which is created by the seller or its agent as the offering party. The real estate marketing package details specific information on the real estate and is distributed to potential buyers or lessees. Traditionally, offering packages are created by each offeror without any standardization as to information contained and layout of the information presented. A significant level of expertise is required in the creation of an effective and comprehensive real estate marketing package. These fields of expertise include; building construction, site review, financial calculations and marketing design. With various and often limited degrees of technical expertise in these fields many offerors are unable to create an adequate and effective offering package. Conventionally a comprehensive real estate marketing package is printed, copied, bound and distributed at significant cost per copy in terms of monetary cost and labor. The time required to create a comprehensive real estate marketing package under the present method in use is extensive, placing a burden upon the offeror and/or its staff. Without effective and comprehensive documentation within the real estate marketing package, the process of marketing what is considered an illiquid asset type is made more difficult, time consuming and costly. With incomplete or unclear information presented to a potential buyer the need for time consuming and costly follow-up information being provided is required. In many cases incomplete or unclear information presented to a potential buyer or lessee may result in that buyer or lessee eliminating the presented property from consideration.

At the present time real estate marketing packages are delivered to recipients through various means. These means include; hand delivery, US Postal Service, overnight carrier or fax machine. The drawbacks of the present delivery methods are time, cost and quality. Given that real property transactions are time sensitive, the delivery of information in a timely manner is exceptionally important. With the delivery method utilizing ground carriers such as the US Postal Service, delays of several days to a week or more are common in the recipient receiving information. Through the use of overnight carriers, information is delivered to the recipient within a 24 hour period, however the cost associated with such delivery makes it impractical for most offerors or agents to utilize in the delivery of all but the most important materials. Hand delivery is time consuming and costly and in many cases impractical given the geographic separation of the parties. Fax copies present an issue of poor quality. Color photographs and maps which are customarily part of an offering package do not transmit through fax machines clearly and the clarity of numbers often is diminished and often unclear.

The Prior Art utilizing the internet for real estate marketing is in general patterned after a multiple listing service, whereby a user will enter information about an available property into a computer database. Those searching for property will enter specific search criteria in hopes of finding a property matching this criteria. If a matching property is found within the database the matching property information will be viewed on the computer screen of the individual conducting the search. The information is limited in nature and open to the general public at large. The information presented on a property is not a real estate marketing package, but a only a brief informational flyer. In most instances instructions are provided to contact the individual who listed the property in order to obtain additional information and a full real estate marketing package utilizing the conventional means discussed above.

### BACKGROUND OF INVENTION-OBJECTS AND ADVANTAGES

Advantages Offered by the Invention

1. Creation of Marketing Materials: The method and system to create a real estate marketing package utilizes computer programming which employs highly technical; yet easy to follow intuitive forms designed to guide the author of the real estate marketing package through the creation process. These forms include detailed elements of all property components and financial aspects so that the creator of the marketing package is prompted to select components significant to the property attributes. Through the use of check boxes, drop down menus and fill in text boxes the user is brought through the process of creating a package in a step-by-step guided fashion. With the elements of the property attributes presented to the user in list form, those with only limited knowledge of building construction can complete a detailed real estate marketing package through the selection process offered by the means of the invention. Each property element is then stored as data in a master database for later recall. The use of these detailed intuitive forms not only prompts the user in satisfying any lack of expertise, but also greatly shortens the length of time associated with the creation of a real estate marketing package. This method therefore provides substantial benefits in real estate marketing package creation to users of all knowledge levels. The author of the real estate marketing

2. package can fully customize their marketing package during the creation process as well as after creation through the editing process made part of the computer programming. The data entered through these intuitive guided forms and stored in a master database are then recalled through computer programming designed for the invention in the creation of a PDF file format that can be viewed using a conventional computer and screen with readily available software which is widely available to the public at little or no charge. One such widely available free PDF file reader is Adobe Acrobat Reader. Adobe Acrobat Reader comes pre-installed on many computers sold through retail outlets and is available for download at no cost through the Adobe website. The compilation of the data entered through the forms presented is manipulated by the inventions computer programming, resulting in a real estate marketing package that is a highly professional and comprehensive marketing presentation package. The package created contains the technical, financial and descriptive attributes of the property required for review of a potential buyer or lessee in a comprehensive and highly readable form.

3. Delivery of Marketing Materials: The invention utilizes a means and method of delivery of real estate marketing packages to the intended recipient that is initiated by the sender or author of the information. The sender will enter the email address of an intended recipient and direct the computer program to notify this recipient by email. The recipient will nearly instantaneously receive an email notice via the internet that the real estate marketing package is available for their viewing. Contained in the email message is a link to the secure server(s) where the real estate marketing package is stored. For the purposes of security to the information a temporary password is generated by the computer programming and provided within the email message. The recipient will follow the provided link and enter the provided password in order to gain access to the real estate marketing package. The real estate marketing package can be reviewed on the recipient's computer screen and/or printed to their local printer. No download of the real estate marketing package is required, providing near instantaneous delivery of the real estate marketing package in a highly cost effective and time effective manner in comparison to the present methods widely utilized in the conduct of the real estate business.

4. Under the Prior Art and current use of the internet for real estate marketing as described above, various multiple listing service style websites are available. The invention must not be confused with such multiple listing type sites. The computer programming of the invention creates full and comprehensive real estate marketing packages, containing the detailed and comprehensive elements required for review and analysis of buyers and lessees rather than limited “flyer” type information provided in a multiple listing service design. Extremely important is the real estate marketing package remains confidential and is not open to public access or review. The invention acts as a delivery service, making the real estate marketing package only available for review and printing to a recipient designated by the sender. The delivery of the information to a recipient is therefore directed by the sender, rather than under Prior Art whereby there is an open and free exchange of limited information between the author of the information and the public at large.

### SUMMARY OF THE INVENTION

The subject invention is directed to a system, means and method of creating and distributing real estate marketing packages to a potential purchasers or lessees. It solves the drawbacks inherent in the Prior Art in that it offers a means to those with limited expertise the ability to create highly comprehensive, technical and effective real estate packages. Further it offers a more time and cost effective means of creating and delivering real estate marketing packages. Through the use of the internet, delivery of the marketing material is near instantaneous, eliminating the time delay, high cost, or quality issues associated with the present delivery methods discussed above.

Through the computer programming and methods of the invention, data sets are recorded by the user, using step-by-step forms including; check boxes, drop down menus and fill in the blank text boxes. The programming then stores these datasets in a master database for recall by the inventions programming to create a full and comprehensive real estate marketing package. Distribution and delivery to an intended recipient of the real estate marketing package is directed by the offeror through the use of internet email with the recipient receiving a near instantaneous message including a link to the password secured real estate marketing package. This real estate marketing package can then be reviewed on the recipient's computer screen and printed to the recipient's printer locally.

### BRIEF DESCRIPTION OF THE DRAWINGS

So that those having ordinary skill in the art to which the disclosed system and method appertains will more readily understand how to make and use the same, reference may be had to the drawings wherein:

FIG. 1 is a drawing referring to the steps and flow of data entailing the means and method of creating and distributing a real estate marketing package.

FIG. 2 is a flow chart diagram of the steps utilized in the creation of a real estate marketing package.

FIG. 3. is a flow chart diagram of the steps utilized in the delivery of a real estate marketing package.

FIG. 4 is a flow chart diagram of the steps utilized by the recipient of the real estate marketing package in its retrieval and printing.

FIG. 5. is an example of the email message the recipient of a real estate marketing package will receive providing notification of the package delivery and instructions on accessing the real estate marketing package.

### DETAILED DESCRIPTIONS OF THE PREFERRED EMBODIMENT

The present invention provides a novel method and system for the creation and delivery of real estate marketing packages. The system and method allows the creations of highly detailed, technical and comprehensive real estate marketing packages utilizing a computer accessing the invention through the internet. The system and method further provides near instantaneous and cost effective manner of delivery of the real estate marketing package to an intended recipient.

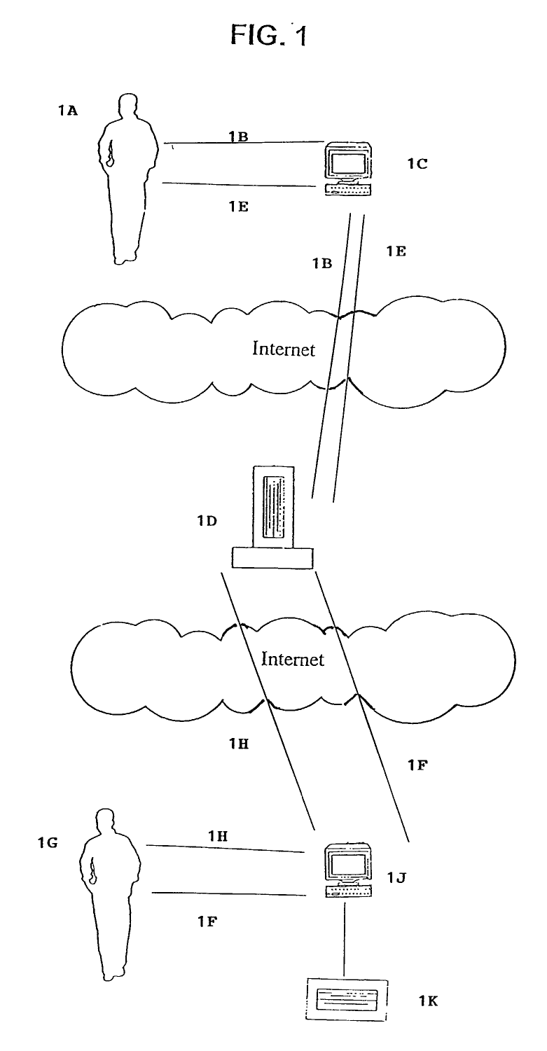

Referring to FIG. 1.

FIG. 1A references a creator of a real estate marketing package utilizing a computer referenced as FIG. 1C. Reference is made to FIG. 1B, an interactive communication between FIG. 1A utilizing FIG. 1C and communicating with programming of the invention through the internet to FIG. 1D referencing a computer server(s) where the computer programming of the invention is accessed. FIG. 1B is an interactive line of communication whereby data is entered into forms provided by the programming of the invention and stored in a master database in FIG. 1D. Computer programming within FIG. 1D manipulates the data stored in the master database and creates a readable document known as a real estate marketing package. Review and editing by FIG. 1A is accomplished through the line of interactive communication FIG. 1B. FIG. 1E references the sending of instructions by FIG. 1A to the computer programming of the invention on FIG. 1D to allow access to a recipient, referenced as FIG. 1G, to the created real estate marketing package created in and stored on FIG. 1D. Computer programming of the invention generates an email message referenced by FIG. 1F containing a link to the stored real estate package in FIG. 1D and a password utilized to validate access to the stored real estate package. FIG. 1G will then follow said link provided in FIG. 1F, and enter the password provided in FIG. 1F. Referenced by FIG. 1H, the real estate marketing package is displayed on the computer screen referenced as FIG. 1J. FIG. 1G may then review the real estate marketing package on FIG. 1J and or print the real estate marketing package. Reference is made to FIG. 1K, a printer connected to FIG. 1J.

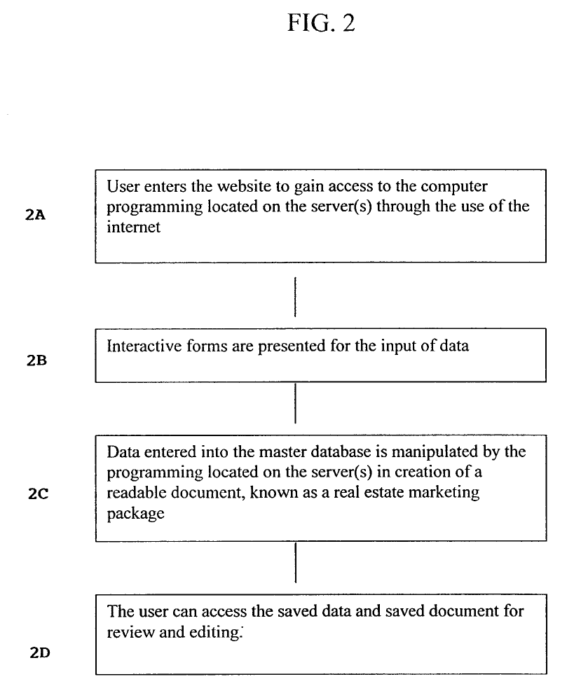

Referring to FIG. 2.

Referring to FIG. 2., a flow chart diagram. A person will enter the website referenced FIG. 2A of the invention to gain access to the computer programming of the invention and located on the server(s) accessed through the use of the internet. Referenced by FIG. 2B interactive forms are presented to the user in which data is entered through the use of forms including; check boxes, selection boxes, drop down menus and text boxes and image files are uploaded. Referring to FIG. 2C the data entered in FIG. 2B is manipulated by the computer programming of the invention and a readable document known as a real estate marketing package is created. Referring to FIG. 2D, the user may review document created in FIG. 2C and edit the document.

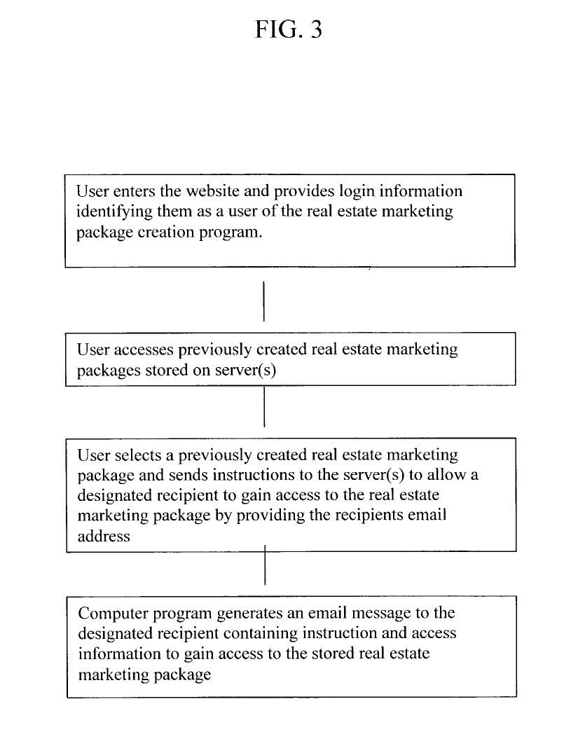

Referring to FIG. 3

Referring to FIG. 3., a flow chart diagram. A person will enter the web site referenced FIG. 3A. They will enter previously designated log in information and password identifying them as a user of the real estate marketing package creation program reference in FIG. 2. FIG. 3B references the access to the previously created and stored real estate marketing packages created by the user. FIG. 3C references the selection of a real estate marketing package to be sent to a recipient designated by the user by entering the recipients email address and sending instructions to the programming located on the server(s) to provide access to the real estate marketing package by the designated recipient. FIG. 3D references the computer programming sending an email to the designated recipient with instructions and access information to gain access to the real estate marketing package.

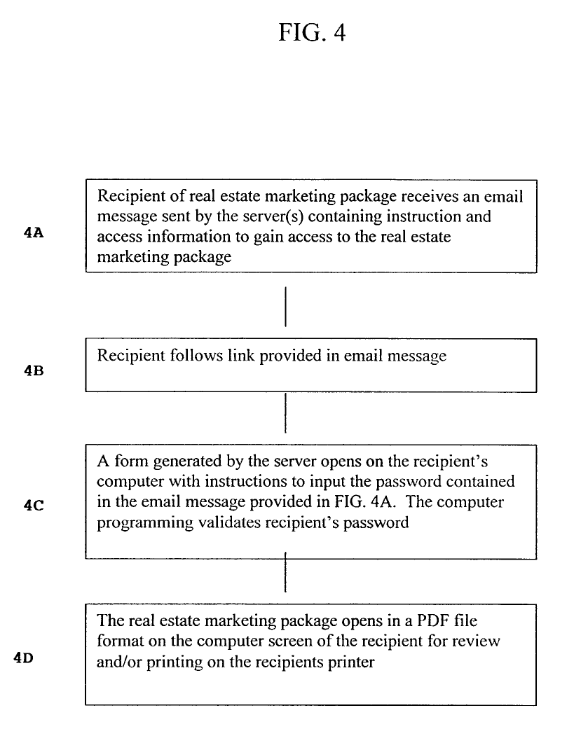

Referring to FIG. 4.

Referring to FIG. 4., a flow chart diagram. An intended recipient will receive an email message sent by the sender in FIG. 3, containing instructions and access information to gain access to a real estate marketing package, referenced by FIG. 4A. FIG. 4B references the intended recipient follow a link provided in FIG. 4A to the location where the real estate marketing package is stored on the server(s) referenced by FIG. 2C. FIG. 4C references a form generated by the server(s) for the inputting of the intended recipients password assigned and referenced in FIG. 4A for validation by the computer program. FIG. 4D references the computer programming allowing the viewing of the real estate marketing package on the intended recipients computer screen and/or printing on the intended recipients printer.

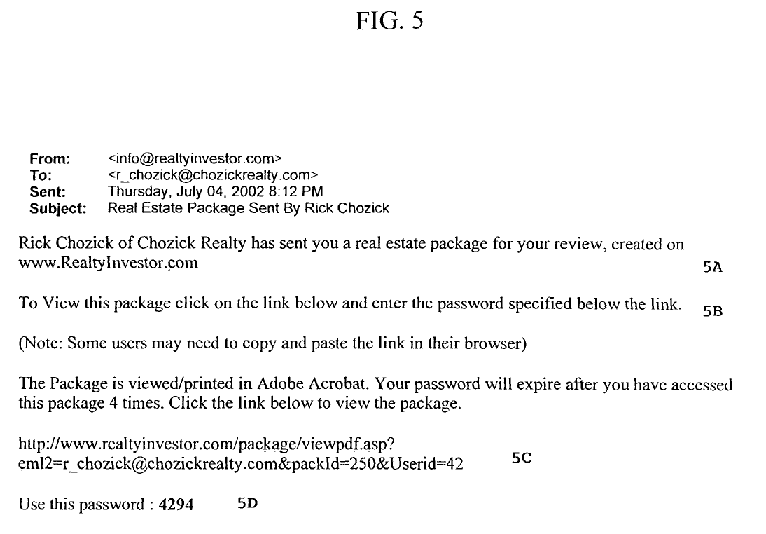

Referring to FIG. 5.

FIG. 5 is an email notification to the recipient of a real estate marketing package generated by the computer programming of the invention. FIG. 5A references and identifies the sender of the real estate marketing package. FIG. 5B references instructions for retrieval of the real estate marketing package. FIG. 5C references the link that the recipient must follow to be provided access to the server(s) where the real estate marketing package is stored. FIC. 5D references the temporary password that the computer programming has assigned to this recipient. Each password assigned is unique to that users email address and will allow access only to the particular package sent to the recipient. To gain access to the stored real estate marketing package, the computer programming utilized in this method will validate the email address and password prior to allowing access to the selected package.

While the invention has been described with respect to the preferred embodiments, those skilled in the art will readily appreciate that various changes and modifications can be made to the invention without departing from the sprit or scope of the invention.

From the description above a number of advantages of the method and system of creating and delivering Real Estate Marketing packages is evident:

(a) The ease in which an author of a real estate marketing package can create a highly detailed, comprehensive and technical marketing package.

(b) The ability to include technical information with limited knowledge through the use of check boxes, drop down menus, selection boxes and fill in text fields.

(c) The ability to add a high degree of customization through addition of uploaded image files and custom pages. In addition sequencing of pages of the real estate marketing package can be determined by the user.

(d) The near instantaneous delivery of the real estate marketing package to an intended recipient, initiated by the sender.

(e) The ability of the intended recipient to gain near instantaneous access the desired information without the need for downloading to their computer.

The benefit of the instant delivery of the real estate marketing package is evident to those skilled in the art. The drawbacks of the present system used by sellers and their agents include the lack of standardization in terms of information and layout, incomplete information due to limit expertise and time and cost associated with the creation of a real estate marketing package. The drawbacks of the current method of delivery of the real estate marketing package employed utilizing the US Mail service, overnight carriers, fax machines or hand delivery are time, cost and quality. The invention offers a solution to both issues by providing near instantaneous delivery of a highly detailed and comprehensive real estate marketing package in a time and cost effective manner.

The benefit to the recipient is the near instantaneous method of delivery so that information on an available property is provided to them without delay. The method of accessing the real estate marketing package without the need for downloading files offers the recipient near instant access to the real estate marketing package in a widely available PDF file format.

What is claimed is:

1. A means and method of creating and accessing real estate marketing packages utilizing computer programming accessed over the internet comprising the steps of:
(a) Providing forms including check boxes, drop down menus, selection boxes, upload forms and text boxes for inputting a plurality of real estate property data.
(b) Providing storage of said inputted data into a master database for later recall by computer programming of the invention.
(c) Retrieval and manipulation of said data by computer programming of the invention in the creation and formatting of a real estate marketing package in a form that is readable on a computer screen.
(d) Providing retrieval of said stored data for the purpose of the inputting party to edit, change or modify said data and edit, change or modify the appearance of the real estate marketing package created from said data.
Whereby the creator of said real estate marketing package through utilizing the means and method herein can create a full, comprehensive and detailed real estate marketing package utilizing forms provided by the invention even if possessing only limited expertise in the fields of real estate and/or marketing. Further the computer programming provided by the invention manipulates said data into a document that is readable on a computer screen.

2. A means and method of the creator of the real estate marketing package or other authorized individual to provide access to an intended recipient of said real estate marketing package comprised of the following steps:
(a) Providing the sending of an email message utilizing the internet to said recipient providing notice and instruction enabling access to said real estate marketing package.
(b) Access to said recipient to said real estate package is provided by supplying a link within said email message to said real estate marketing package.
(c) Utilizing the internet the recipient uses said link provided in said email message to open said real estate marketing package on a computer screen.
(d) Providing for the review by said recipient of said real estate marketing package on their computer screen and/or printing said real estate marketing package on their local printer.
Whereby the recipient gains the advantage of near instant access to said real estate marketing package and the information therein.

3. A means and method according to claim 2 eliminating the need for said recipient of said real estate marketing package to download and save said real estate marketing package to their local computer due to the method of the invention whereby the document is stored on the server(s) of the invention.
Whereby the recipient saves substantial download time and storage space on recipients computer.

4. A means and method utilizing the internet providing near instantaneous notification to a recipient and allowing near instantaneous access to said recipient to said real estate marketing package utilizing the internet.
